(19) United States
(12) Patent Application Publication
(10) Pub. No.: US 2010/0262622 A1
(43) Pub. Date: Oct. 14, 2010

(54) INFORMATION PROVIDING APPARATUS, INFORMATION PROVIDING METHOD, AND COMPUTER-READABLE RECORDING MEDIUM IN WHICH INFORMATION PROVIDING PROGRAM IS RECORDED

(75) Inventor: HIROFUMI SAITO, TOKYO (JP)

Correspondence Address: YOUNG & THOMPSON, Second Floor, 745 South 23rd Street, Arlington, VA, 22314, US

(73) Assignees: PIONEER CORPORATION, TOKYO (JP); INCREMENT P CORPORATION, TOYKO (JP); MOBILEMEDIA BRAIN ASSOCIATION, INC., TOKYO (JP)

(21) Appl. No.: 12/754,674

(22) Filed: Apr. 6, 2010

(30) Foreign Application Priority Data
Apr. 8, 2009 (JP) P2009-93779

(51) Int. Cl. G06F 17/30

(52) U.S. Cl. 707/780; 707/E17.014

(57) ABSTRACT

In an information providing apparatus, a keyword attribute file KF which brings a keyword which can be inputted by a user, a keyword attribute corresponding to the keyword, and a judgment value in correspondence with each other is referred to, and based on a comparison of a judgment value corresponding to an input keyword with a judgment reference value, a keyword attribute is extracted, and based on the extracted keyword attribute and an input keyword, information to be searched is searched, and provided to a user.

### BACKGROUND OF THE INVENTION

1. Field of the Invention

The present invention relates to an information providing apparatus, an information providing method, and a computer-readable recording medium in which an information providing program is recorded.

2. Discussion of Related Art

In recent years, a navigation apparatus is spread, which searches a route from the present position to a destination, performs a guidance of guiding a user to the destination. In a navigation apparatus, first, in order to set a destination, it is necessary to search position information (for example, latitude and longitude information, address information) indicative of a position to be set as a destination. Therefore, a variety of technologies of searching position information, such as a name search, an address search, and a telephone number search, are disclosed (for example, Patent Document Nos. 1 and 2). A name search is a search method of searching position information based on a character string (a keyword) included in a name of a facility. An address search is a search method of searching position information by making a user select an area “a region (the Tohoku region, the Kanto region, the Chubu region, the Kansai region, etc.)”→“prefecture”→“city, ward, town, village”→—in a step-by-step manner. A telephone number search is a search method of searching position information by narrowing the scope of facilities based on the telephone numbers of facilities.

A method of searching a position by a keyword search is also known. In the case where a keyword search is conducted, when a keyword is inputted, it has to be selected as which attribute (for example, an address, a name of facility, a genre) an input keyword is treated. For example, in the case where a Chinese noodles shop named “0XA#” is searched, after it has been selected that an input keyword is treated as an attribute of “a shop” (or an attribute of “a Chinese noodles shop”) before a keyword is inputted, a name of “0XA#” has to be inputted by using 50-sound keys.
Patent Document No. 1: Japanese Patent Laid-open No. 11-271084
Patent Document No. 2: Japanese Patent Laid-open No. 2008-249451

### SUMMARY OF THE INVENTION

In the above-mentioned prior art, however, there may be cases where, when a user conducts a keyword search, he is confused about judging which attribute is the optimum in treating an input keyword, and this is a load on a user.

The present invention has been accomplished in view of the above problem, and it is an object of the invention to provide an information providing apparatus, an information providing method, and a computer-readable recording medium in which an information providing program is recorded, which are capable of reducing the user' s load at the time of conducting a keyword search of searching position information.

In order to solve the above problem, in one aspect of the invention, the invention according to claim 1 relates to an information providing apparatus for searching information to be searched based on a keyword inputted by a user, and a keyword attribute corresponding to the keyword, and providing it to a user, the information providing apparatus comprising:

a storage device configured to store attribute correspondence information which brings a keyword which can be inputted by a user in correspondence with one or a plurality of keyword attributes, and ties a judgment value to each of the keyword attributes,

an extraction device configured to refer to the attribute correspondence information, and to perform an extraction process of extracting a keyword attribute based on the judgment value tied to a keyword attribute corresponding to the inputted keyword, and a predetermined extraction threshold which is an extraction reference of the keyword attribute, and

a providing device configured to search information to be searched based on a keyword attribute extracted by the extraction device, and the inputted keyword, and provide it to a user.

Further, in another aspect of the invention, the invention according to claim 10 relates to an information providing method, comprising:

an extraction process of bringing a keyword which can be inputted by a user in correspondence with one or a plurality of keyword attributes, referring to attribute correspondence information which ties a judgment value to each of the keyword attributes, and based on the judgment value tied to a keyword attribute corresponding to a keyword inputted by a user, and a predetermined extraction threshold which is an extraction reference of the keyword attribute, extracting a keyword attribute, and

a providing process of searching information to be searched based on a keyword attribute extracted in the extraction process, and the inputted keyword, and provide it to a user.

Further, in still another aspect of the invention, the invention according to claim 11 relates to a computer-readable recording medium in which an information providing program is recorded,

the information providing program making a computer included in an information providing apparatus which comprises a storage device configured to store attribute correspondence information which brings a keyword which can be inputted by a user in correspondence with one or a plurality of keyword attributes, and ties a judgment value to each of the keyword attributes, the information providing apparatus searching information to be searched based on a keyword inputted by a user, and a keyword attribute of the keyword, and providing it to a user, function as:

an extraction device configured to refer to the attribute correspondence information, and based on the judgment value tied to a keyword attribute corresponding to the inputted keyword, and a predetermined extraction threshold which is an extraction reference of the keyword attribute, perform an extraction process of extracting a keyword attribute, and

a providing device configured to search information to be searched based on a keyword attribute extracted by the extraction device, and the inputted keyword, and provide it to a user.

### BRIEF DESCRIPTION OF THE DRAWINGS

FIG. 1 is a block diagram showing an example of a concrete structure of a navigation apparatus 100 in which an information providing apparatus and an information providing method according to the embodiment are used.

FIG. 2 is a diagram showing an example of a structure of a keyword attribute file recorded in a HD drive 102 of a navigation apparatus 100 according to the embodiment.

FIG. 3 is a diagram showing an example of a keyword input screen 300 in the embodiment.

FIGS. 4A to 4D are diagrams showing an example of a search work file WF in the embodiment.

FIG. 5 is a diagram showing an example of a search method selection screen 400 in the embodiment.

FIG. 6 is a diagram showing an example of a search method selection screen 500 in the embodiment.

FIG. 7 is a diagram showing an example of a search result screen 600 in the embodiment.

FIG. 8 is a diagram showing an example of a search work file WF in the embodiment.

FIGS. 9A to 9C are diagrams showing an example of a search work file WF in the embodiment.

FIG. 10 is a diagram showing an example of a search method selection screen 700 in the embodiment.

FIG. 11 is a diagram showing an example of a search method selection screen 800 in the embodiment.

FIG. 12 is a diagram showing an example of a search result screen 900 in the embodiment.

FIG. 13 is a diagram showing an example of a search work file WF in the embodiment.

FIG. 14 is a flowchart showing an example of a position search process performed by a system control unit 101 in the embodiment.

FIG. 15 is a flowchart showing an example of a keyword search process (I) performed by a system control unit 101 in the embodiment.

FIG. 16 is a flowchart showing an example of a keyword attribute extraction process (I) performed by a system control unit 101 in the embodiment.

FIG. 17 is a flowchart showing an example of a keyword search process (II) performed by a system control unit 101 in the embodiment.

FIG. 18 is a flowchart showing an example of a keyword attribute extraction process (II) performed by a system control unit 101 in the embodiment.

### DETAILED DESCRIPTION OF THE PREFERRED EMBODIMENTS

### [1] Embodiments

### [1.1] A Structure of a Navigation Apparatus 100 According to the Embodiment

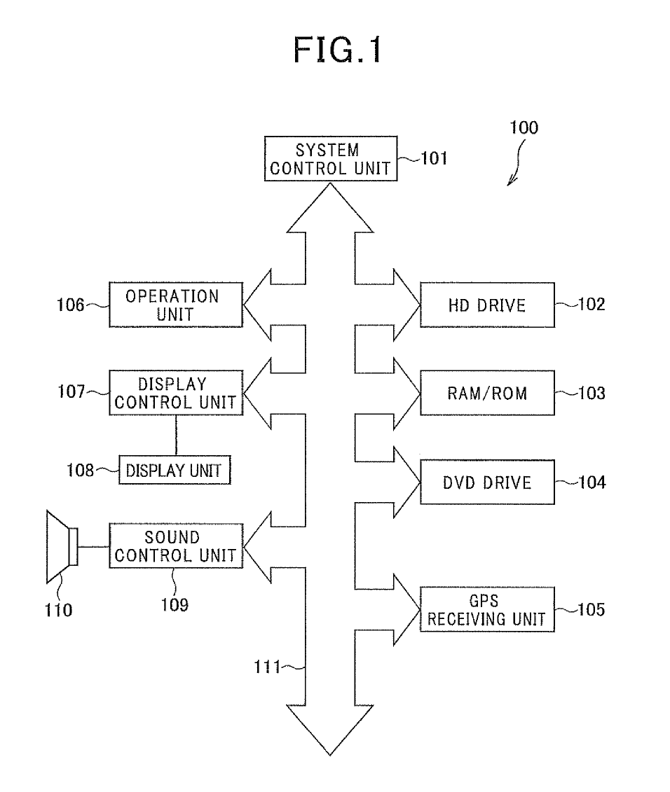

Referring first to FIG. 1, a structure of a navigation apparatus 100 according to the embodiment will be described. As shown in FIG. 1, a navigation apparatus 100 according to the embodiment includes a system control unit 101, a HD drive 102, a ROM (Read Only Memory)/RAM (Random Access Memory) 103, a DVD drive 104, a GPS (Global Positioning System) receiving unit 105, an operation unit 106, a display control unit 107, a display unit 108, a sound control unit 109, a speaker 110, and a data bus 111 which connects these units to each other.

In the navigation apparatus 100, data for displaying a map, and data for searching a position are recorded in the HD drive 102, and by using such data, a function of conducting a variety of position search, such as a name search, a periphery search, a telephone-number search, a keyword search, is realized. Here, a periphery search is a search method of searching position information concerning a variety of facilities existing on the periphery of the position, on a map, indicated by a user. Further, a keyword search is a search method of searching position information concerning a facility, an address, or the like derived from a keyword inputted by a user (hereinafter, referred to as “input keyword”). In the navigation apparatus 100, while the position information searched by utilizing the function is utilized, and an optimum route from the present position of the navigation apparatus 100 to the position set as a designation is calculated.

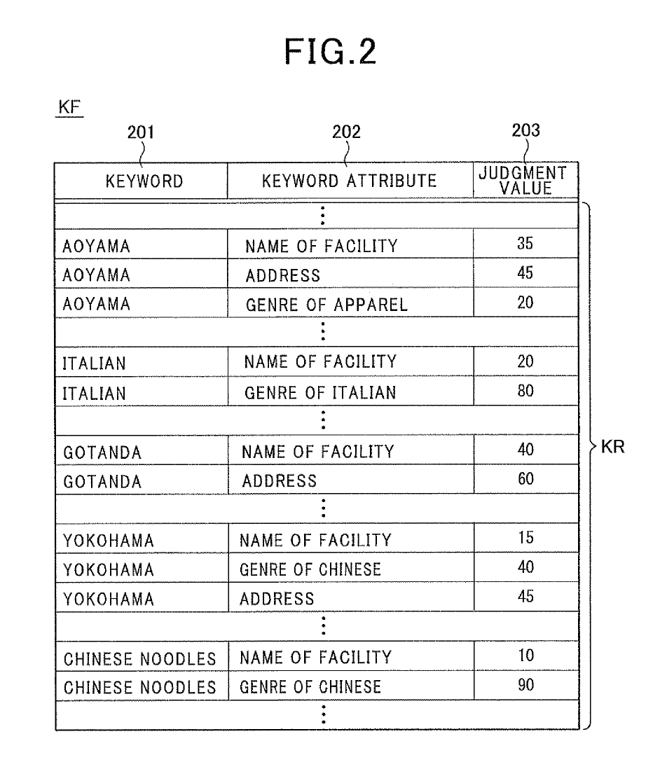

A keyword attribute file KF as shown in FIG. 2 is recorded in the HD drive 102. FIG. 2 is a diagram showing an example of a file structure of a keyword attribute file KF recorded in the HD drive 102. The keyword attribute file KF is a file which is used in the keyword search.

The keyword attribute file KF is composed of a plurality of keyword attribute records KR, each of which includes a keyword 201, a keyword attribute 202, and a judgment value 203 as components. As the keyword 201, a keyword which can be inputted as an input keyword when a keyword search function is utilized is described. The keyword attribute 202 describes as which attribute a keyword described as the keyword 201 is treated in a keyword search. That is, one or a plurality of keyword attributes correspond to one keyword. For example, in an example shown in FIG. 2, “a name of facility” and “an address” are described as a keyword attribute of a keyword “Gotanda”. In the case where a keyword “Gotanda” is treated as a keyword attribute “a name of facility”, a facility whose name includes “gotanda” is searched, and in the case where a keyword “Gotanda” is treated as a keyword attribute “an address”, a facility whose address includes “gotanda” is searched.

The judgment value 203 is a value of reference for judging which keyword attribute an input keyword is treated as. Specifically, a keyword attribute whose judgment value is higher than or equal to a predetermined value of reference for judgment is extracted (hereinafter, referred to as “a judgment value comparison process”), and if the number of extracted keyword attributes is one, position information is searched based on the keyword attribute and the input keyword. If the number of extracted keyword attributes is plural, any keyword attribute is selected from such keyword attributes by a user, and then, position information is searched based on the selected keyword attribute and the input keyword. A total of judgment values assigned to one keyword 201 is “100”. In an initial condition, each keyword is preset based on an empirical rule indicating which keyword attribute each keyword is in many cases treated as, or is set in such a way that the judgment values of the respective keyword attributes are equal to each other. However, in the case where any keyword attribute has been selected by a user as mentioned above, a judgment value is updated in such a way that the keyword attribute selected by the user is easy to extract in a judgment value comparison process next time and thereafter. That is, a keyword attribute file KF shown in FIG. 2 shows an example of a keyword attribute file KF at a certain time.

In position search data recorded in the HD drive 102, data for conducting a position search based on a keyword attribute and an input keyword is included, and in the case where a position search is conducted based on a keyword attribute and an input keyword, such data is referred to.

The GPS receiving unit 105 receives a GPS radio wave transmitted by a land surveying satellite, calculates latitude and longitude corresponding to the present position of the navigation apparatus 100 based on the received GPS radio wave, and outputs the calculated latitude and longitude as GPS data to the system control unit 101.

To the display control unit 107, map data read from the HD drive 102, and screen display data for displaying a screen used at the time of realizing a variety of functions are supplied. The display control unit 107, under the control of the system control unit 101, produces an image data corresponding to a map in a buffer memory (not shown) based on the supplied map data or the like, reads the produced image data from the buffer memory at predetermined timings, and outputs it to the display unit 108. The display unit 108 may be composed of any display device, for example, a CRT (Cathode Ray Tube), an organic EL (Electro Luminescent) panel, a liquid crystal display panel, or the like.

The operation unit 106 is composed of a remote control device or the like which includes a variety of keys such as a numeric keypad, a decision key, or the like, and outputs a control signal corresponding to an input operation performed by a user, to the system control unit 101. The operation unit 106 may be composed of another input device such as a touch panel provided on the display unit 108.

The sound control unit 109 produces a sound signal, and causes the speaker 110 to output such a produced sound signal, under the control of the system control unit 101. By such a function of the sound control unit 109, a navigation apparatus 100 according to the present embodiment, for example, notifies a user of the direction of travel of vehicle at the next intersection.

The system control unit 101 is, mainly, composed of a CPU (Central Processing Unit), includes a variety of input/output ports such as a GPS receiving port, a key-input port, a display-unit control port, and centralized-controls the whole function of the navigation apparatus 100. At the time of such a control, the system control unit 101 reads a control program recorded in the ROM/RAM 103 to perform each process, and causes data being processed to be temporarily held in the ROM/RAM 103.

For example, the system control unit 101 performs a updating process of a variety of files recorded in the HD drive 102, and performs a variety of searches. Further, the system control unit 101 controls the display control unit 107 in such a way that an optimum route from the present position to a destination is calculated, and route guidance information corresponding to the calculated route is displayed on a map corresponding to the present position.

### [1.2] A Change of Screen and a Flow of Process at the Time of Searching a Keyword in the Embodiment

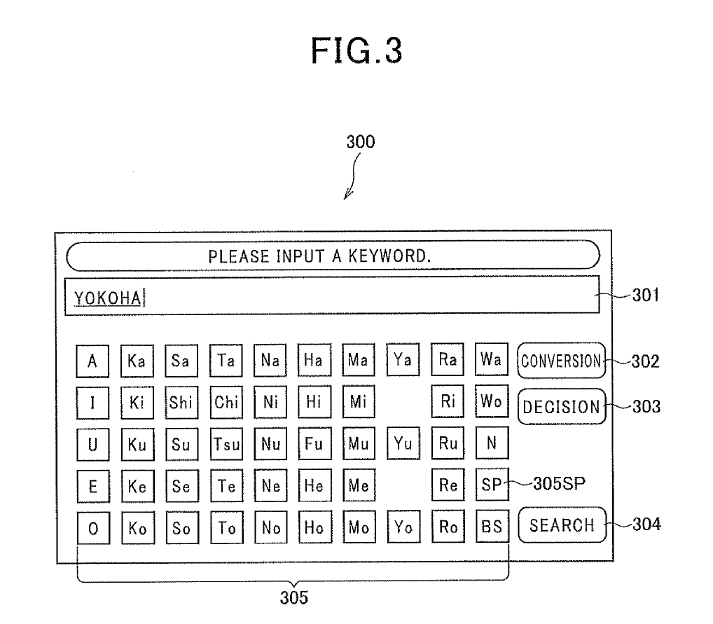

Referring now to FIGS. 3 to 13, in a navigation apparatus 100 according to the embodiment, a flow from the time when a position which is a destination is searched by a keyword search to the time when the destination is set will be described in detail.

First, in a navigation apparatus 100 according to the embodiment, in the case where a user conducts a keyword search, and sets a position which is a destination, it is necessary to perform a predetermined start operation of keyword search for the operation unit 106. A concrete operation at this time is arbitrary. For example, it may be possible that a start button of keyword search is provided in a remote control device of the operation unit 106, and when the button is pressed, a process is started.

When a predetermined start operation of keyword search is performed, a keyword input screen 300 only for a keyword search as shown in FIG. 3 is displayed in the display unit 108. The keyword input screen 300 includes a keyword input area 301, a conversion button 302, a decision button 303, a search button 304, and a 50-sound input key 305. A user can input a keyword in the keyword input area 301, using the 50-sound input key 305, the conversion button 302, and the decision button 303. For example, it is possible that a Japanese Kana-character is inputted using the 50-sound input key 305, the inputted Japanese Kana-character is converted to a Japanese Katakana-character, a Japanese Kanji-character, or the like by pressing the conversion button 302, and the converted character is decided by pressing the decision button 303. A space is inserted between the respective keywords by a space key 305SP to divide the respective keywords, so that a plurality of keywords can be inputted simultaneously. A user inputs a keyword in the keyword input area 301, and then, presses the search button 304, so that the user can cause a search of position which is a destination to be started based on an input keyword inputted in the keyword input area 301. The user's operation of a key, a button, or the like on a variety of screens displayed in the display unit 108, and the user's pressing of a key, a button, or the like are realized by the fact that the user causes a button or the like on a variety of the screens to be in a selection condition by a cursor key of a remote control device, and presses a decision key of the remote control device.

Now, a flow performed after a user inputs an input keyword in the keyword input area 301, and presses the search button 304 will be described.

### [1.2.1] In the Case Where the Number of Input Keywords is One

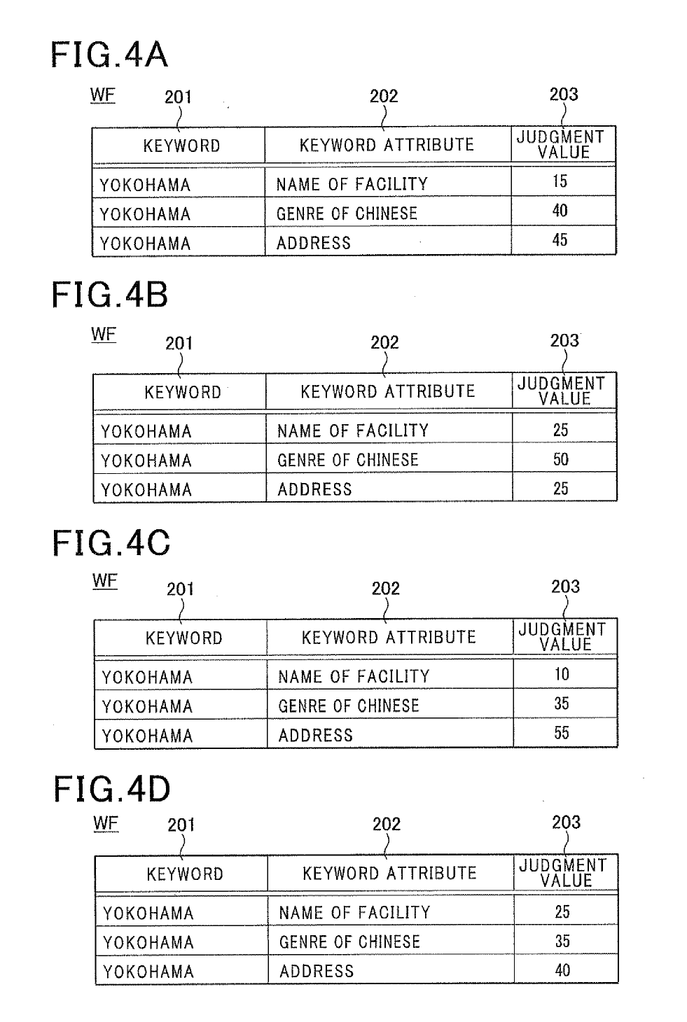

Here, as an example of the case where the number of input keywords is one, the case where an input keyword is one input keyword, i.e., “Yokohama” will be described. When a user presses the search button 304, first, a search work file WF is produced based on a keyword attribute file KF. As shown in FIG. 4A, the search work file WF is a work file produced by replicating only a keyword attribute record KR corresponding to an input keyword in the keyword attribute file KF. Here, since an input keyword is only “Yokohama”, the search work file WF for a keyword “Yokohama” is produced.

After the search work file WF has been produced, then, it is judged whether a record whose keyword attribute is “an address” exists in the search work file WF. At this time, in the case where a record whose keyword attribute is “an address” exists, then, it is judged whether an input keyword is a keyword indicative of an address indicative of a position included in a predetermined scope from the present position indicated by GPS data.

The above mentioned “a predetermined scope” can be adequately set, if necessary. For example, a prefecture which includes the present position may be “a predetermined scope”, as one example. Specifically, if the present position is any position in “Kawasaki city”, and an input keyword is “Yokohama”, they are in the same prefecture, i.e. , in “Kanagawa prefecture”. Therefore, it is judged that an input keyword is a keyword indicative of an address indicative of a position included in a predetermined scope from the present position. As another example, a scope of a predetermined distance (for example, 20 km) from the present position, or a scope of a predetermined-time travel (for example, a 30-minute travel) from the present position may be “a predetermined scope”. In the case where an input keyword indicative of an address indicates a certain area, a judgment is made while a representative position of the address is set as a reference.

At this time, in the case where an address indicated by an input keyword indicates a position outside a predetermined scope from the present position, the following present-position consideration process is performed: a predetermined subtraction value (In the embodiment, as an example, it is “20”. However, it maybe another value, if necessary.) is temporarily subtracted from a judgment value tied to a keyword attribute “address” in the search work file WF, and a value is equally added to judgment values tied to the other keyword attributes in such a way that a total of judgment values assigned to one keyword is maintained to be “100” (If there is a keyword attribute whose judgment value is equal to or lower than “0” based on the subtraction of value, however, an update of value is not performed.). Here, a search work file WF shown in FIG. 4B indicates a condition after the present-position consideration process has been performed for a search work file WF shown in FIG. 4A. On the other hand, in the case where an address indicated by an input keyword indicates a position in a predetermined scope from the present position, the present-position consideration process is not performed. With the present-position consideration process, in the case where an input keyword is a keyword indicative of an address indicative of a position outside a predetermined scope from the present position, “an address” is difficult to extract as a keyword attribute in a comparison process of judgment value. A judgment value revised by the present-position consideration process is returned to a condition assumed before the revision, after a judgment-value comparison process has been performed. Therefore, in the case where the present-position consideration process is performed, a judgment value assumed before the revision is temporarily saved.

Then, a judgment-value comparison process is performed. Specifically, each judgment value included in the search work file WF and a judgment reference value (in the embodiment, as an example, in the case where the number of an input keyword is one, it is “40”. However, it may be another value based on the number of keyword attributes or the like corresponding to a keyword, if necessary.) are compared with each other, and a keyword attribute tied to a judgment value equal to or more than the judgment reference value is extracted. In the case where the present-position consideration process has been performed, a judgment value in the search work file WF is returned to a condition assumed before the revision, after a judgment-value comparison process.

### [1.2.1.1] Case 1-1 (In the Case Where the Number of Keyword Attributes Extracted at a Judgment-Value Comparison Process is Plural)

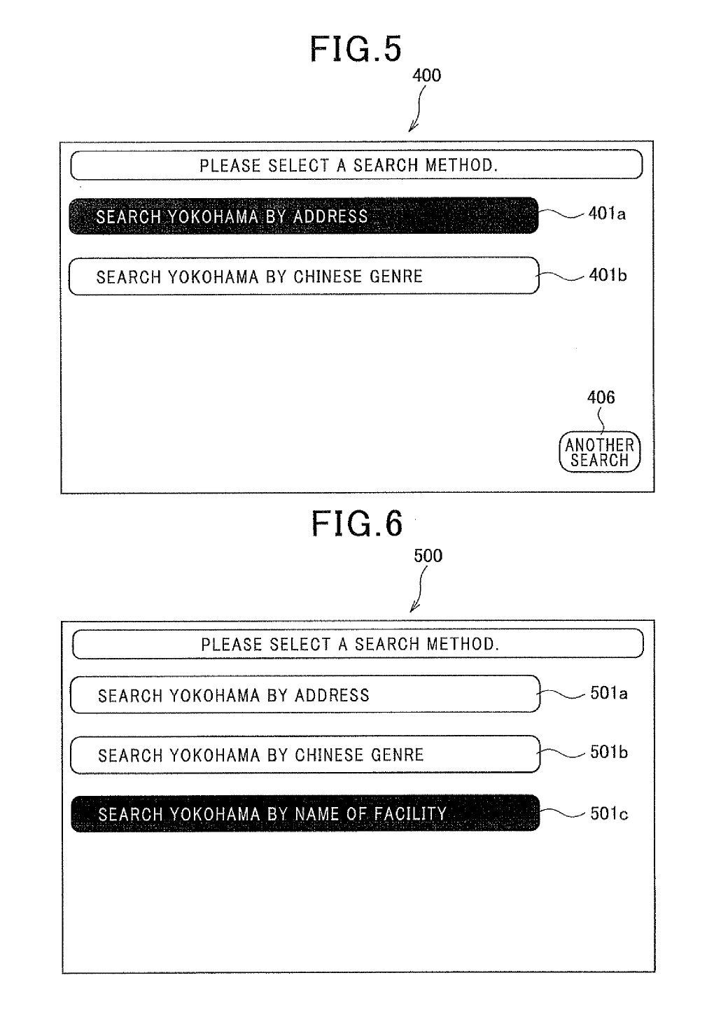

In the case where a judgment-value comparison process has been performed based on each judgment value included in the search work file WF shown in FIG. 4A and a judgment reference value, “an address” and “Chinese genre” are extracted as a keyword attribute. In this case, in order to make a user select any keyword attribute of “an address” and “Chinese genre”, and an input keyword which a position search is performed based on, a screen is changed from a keyword input screen 300 to a search method selection screen 400 shown in FIG. 5.

In the search method selection screen 400, search method display areas 401a, 401b, and “another search” button 406 are included. In the search method display areas 401a, 401b, in order to make a user select any of keyword attributes extracted by a judgment-value comparison process, a search method corresponding to each keyword attribute is displayed. In a search method display area 401, keyword attributes to be selected by a user are displayed in decreasing order of judgment values in a search work file WF. That is, since a judgment value tied to “an address” is greater than a judgment value tied to “Chinese genre” as shown in FIG. 4A, “search Yokohama with an address” is displayed in the search method display area 401a, and “search Yokohama with Chinese genre” is displayed in the search method display area 401b. Here, a user can select any keyword attribute (a search method) which a position search is performed based on. Specifically, any search method display area 401 becomes to a selection condition by operating a cursor key, and a keyword attribute (a search method) corresponding to a search method display area 401 which has become to a selection condition can be selected by operating a decision key. After any keyword attribute has been selected by a user, a judgment value of a search word file WF is updated in accordance with a predetermined learning rule.

Here, a learning rule in the case where any keyword attribute has been selected by a user will be described. The learning rule can be adequately set, if necessary. For example, as one example, the following learning rule may be available: in the case where any keyword attribute has been selected by a user, a predetermined addition value (in the embodiment, as an example, it is “10”. However, it may be another value, if necessary.) is added to a judgment value tied to the selected keyword attribute of search work file WF, and a value is equally subtracted from judgment values tied to the other keyword attributes in such a way that a total of judgment values assigned to the respective keywords is maintained to be “100” (However, in the case where there is a keyword attribute whose judgment vale becomes equal to or less than “0” by subtracting a value, all judgment values are not updated.). FIG. 4C is a view showing a search work file WF shown in FIG. 4A whose judgment value has been updated in accordance with the learning rule (in the case where a predetermined addition value is “10”), in the case where “an address” has been selected as a keyword attribute by a user As another example, a predetermined addition value may change in accordance with the magnitude of a judgment value to which the predetermined addition value should be added, or the magnitude of a judgment value tied to another keyword attribute. For example, the nearer to “100” a judgment value of a certain keyword attribute is (or, the nearer to “0” it is), the smaller a predetermined addition value may be. Thus, it is called “a learning process” in the embodiment that a judgment value is updated in accordance with a learning rule based on the fact that a user has selected a keyword attribute.

Further, when “another search” button 406 on a search method selection screen 400 shown in FIG. 5 is operated by a user, in order to make a user select any keyword attribute of all keyword attributes of a search work file WF (in the case of a search work file WE shown in FIG. 4A, “an address”, “Chinese Genre”, and “a name of facility) and an input keyword which a position search is conducted based on, s screen is changed from the search method selection screen 400 to a search method selection screen 500 shown in FIG. 6.

The search method selection screen 500 includes search method display areas 501a, 501b, and 501c. In order to make a user select any of all keyword attributes in a search work file WF, a search method corresponding to each keyword attribute is displayed in each of the search method display areas 501a, 501b, and 501c. Similarly with a search method selection screen 400, keyword attributes to be selected by a user are displayed in the respective search method display areas 501 in decreasing order of judgment values in a search work file WF. Similarly with a case in a search method selection screen 400, a user can select any keyword attribute (any search method) which a position search is conducted based on. Here, in the case where any keyword attribute has been selected by a user, similarly with the above, a judgment value in a search work file WF is updated in accordance with a predetermined learning rule. In the case where a user has selected a keyword attribute “a name of facility” in accordance with the learning rule, a search work file WF assumed before an update is shown in FIG. 4A, and a search work file WF assumed after an update is shown in FIG. 4D. Thus, in the case where a keyword attribute has been selected on a search method selection screen 500 by a user, a learning process is also performed.

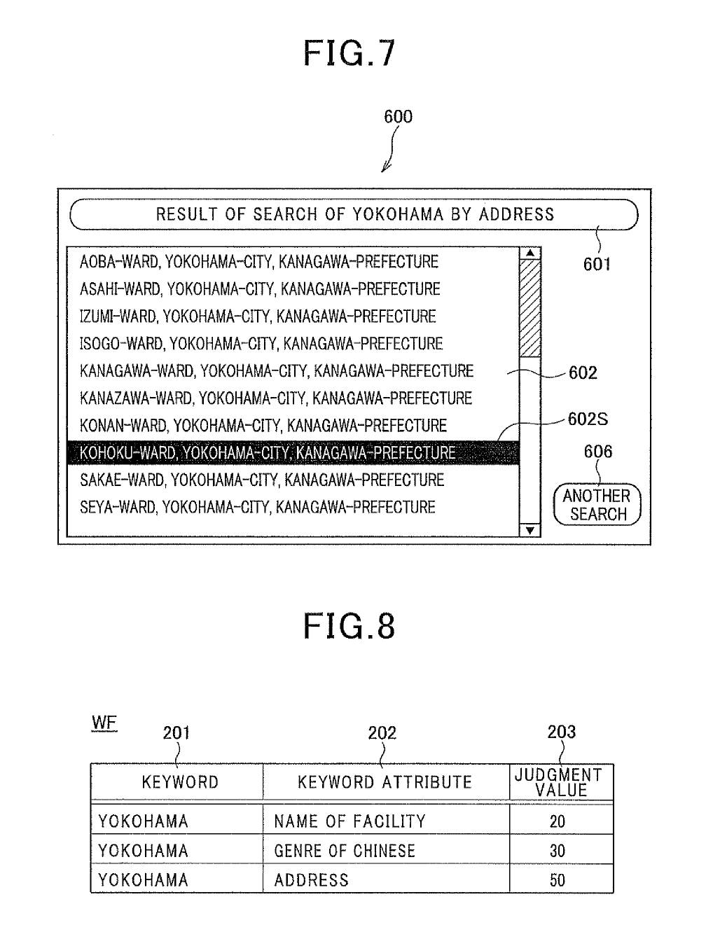

When any keyword attribute in a search method selection screen 400 or a search method selection screen 500 is selected by a user, a position search is conducted based on the selected keyword attribute and an input keyword, and a screen is changed from a search method selection screen 400, 500 to a search result screen 600 shown in FIG. 7. The search result screen 600 includes a keyword/keyword attribute display area 601, a search result display area 602, and “another search” button 606. In the keyword/keyword attribute area 601, information indicative of any input keyword and any keyword attribute which a position search has been conducted based on is shown. An example shown in FIG. 7 shows that a position search has been conducted based on an input keyword “Yokohama” and a keyword attribute “an address”. The search result display area 602 shows a result of a position search conducted based on a keyword attribute and an input keyword. Each area which shows a piece of position information searched in the search result display area 602 can be made into a selection condition by a cursor key. An example shown in FIG. 7 shows that an area 602S which shows “Kohoku-ward, Yokohama-city, Kanagawa-prefecture” as position information is in a selection condition. By making any area in a search result display area 602 into a selection condition, and then pressing a decision button, a user can decide a position indicated by position information displayed in an area which is in the selection condition, as a destination. After a destination has been decided, a judgment value of the corresponding keyword attribute record KR in a keyword attribute file KF is updated based on a search work file WF.

Further, in the case where “another search” button 606 has been operated by a user, a judgment value of a search work file WF updated so far by a learning process is returned to a condition assumed before a learning process is performed. In addition thereto, in order to make a user select again a keyword attribute other than a keyword attribute shown in a keyword/keyword attribute display area 601 from all keyword attributes of a search work file WF, a screen is changed from a search result screen 600 to a search method selection screen 500.

### [1.2.1.2] Case 1-2 (In the Case Where the Number of Keyword Attributes Extracted in a Judgment Value Comparison Process One)

On the other hand, in the case where a judgment value comparison process has been performed based on each judgment value included in a search work file WF shown in FIG. 8 and a judgment reference value, only “an address” is extracted as a keyword attribute. In this case, a position search is performed based on a keyword attribute extracted by the judgment value comparison process, and an input keyword, and a screen is changed from a keyword input screen 300 directly to a search result screen 600 shown in FIG. 7. A flow after a search result screen 600 has been displayed is similar with the case in which a search result screen 600 has been displayed in the case 1-1. In the case 1-2, however, if a destination is decided based on position information shown in a search result display area 602 while “another search” button 606 is not pressed when a search result screen 600 is first displayed, a learning process is never performed, and a process of updating a judgment value of a keyword attribute file KF based on a search work file WF is never performed.

### [1.2.2] In the Case Where the Number of Input Keywords is Plural.

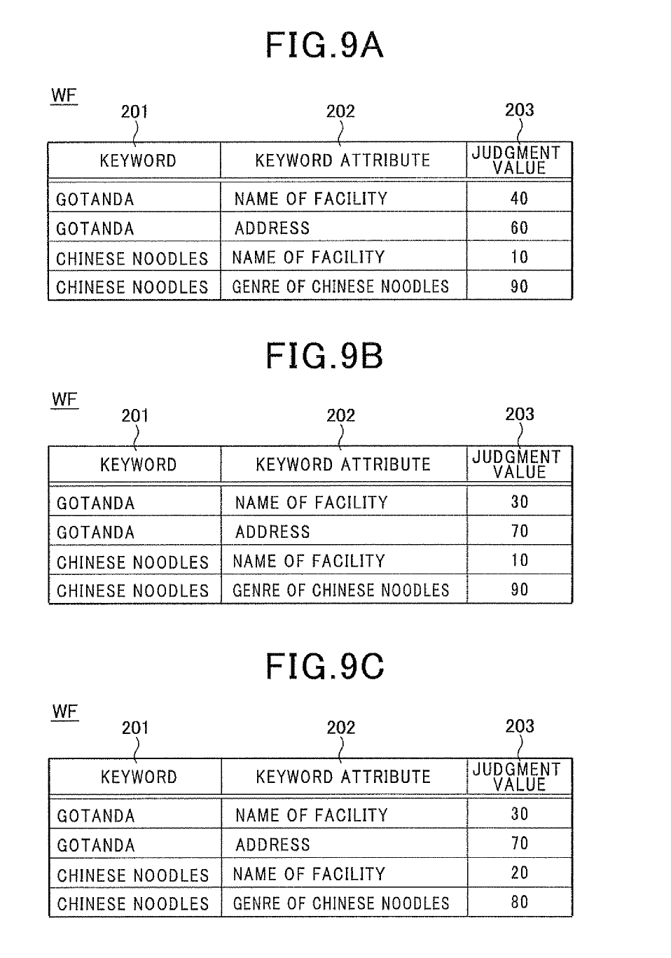

Now, as an example in which the number of input keywords is plural, the case where the number of input keywords is two, i.e., “Gotanda” and “Chinese noodles” will be described. When a search button 304 on a keyword input screen 300 is pressed by a user, a search work file WF is produced based on a keyword attribute file KF, similarly with the case where the number of input keywords are one. Here, since input keywords are “Gotanda” and “Chinese noodles”, a search work file WF in which keywords are “Gotanda” and “Chinese noodles” is produced, as shown in FIG. 9A.

After a search work file WF has been produced, then, it is judged whether a record in which a keyword attribute is “an address” exists in the search work file WF, and it is judged whether the above present-position consideration process should be performed. Since an outline of the present-position consideration process has been already described, a description thereof will be omitted. In the case where the number of records which exist in an search work file WF and in which a keyword attribute is “an address” is plural, it is judged whether the above present-position consideration process should be performed individually.

Now, a set of keyword attributes which is composed of keyword attributes included in a search work file WF is formed. Specifically, a set of keyword attributes which is composed of a combination of keyword attributes included in a search work file WF and corresponding to the respective different keywords is formed. In an example shown in FIG. 9A, a set of “Gotanda (a name of facility)+Chinese noodles (a name of facility)”, a set of “Gotanda (a name of facility)+Chinese noodles (a genre of Chinese noodles)”, a set of “Gotanda (an address)+Chinese noodles (a name of facility)”, and a set of “Gotanda (an address)+Chinese noodles (a genre of Chinese noodles)” are formed.

Then, a judgment value comparison process is performed. In a judgment value comparison process in the case where the number of input keywords are plural, by the fact that a judgment value tied to a keyword attribute which constitutes a set of keyword attributes is compared with a judgment reference value, a set of keyword attributes is extracted. As an example of a judgment value comparison process in the case where the number of input keywords is plural, in the embodiment, a set of keyword attributes is extracted, (A) in which a total judgment value obtained by summing up judgment values tied to keyword attributes which constitute a set of keyword attributes is equal to or more than a total judgment reference value (in the embodiment, as an example, in the case where the number of input keywords is two, it is “100”. However, it may be another value based on the number of keyword attributes corresponding to keywords, or the like, if necessary.), and (B) in which a judgment value tied to all keyword attributes which constitute a set of keyword attributes is equal to or more than a judgment reference value (in the embodiment, as an example, in the case where the number of input keywords is two, it is “30”. However, it may be another value based on the number of keyword attributes corresponding to keywords, or the like, if necessary.). A set of keyword attributes which fulfills at least one of the above conditions (A) and (B) may be arranged to be extracted. In the case where the above present-position consideration process has been performed, after a judgment value comparison process has been performed, a judgment value of a search work file WF is returned to a condition assumed before such a revision.

### [1.2.2.1] Case 2-1 (In the Case Where the Number of Sets of Keyword Attributes Extracted in a Judgment Value Comparison Process is Plural)

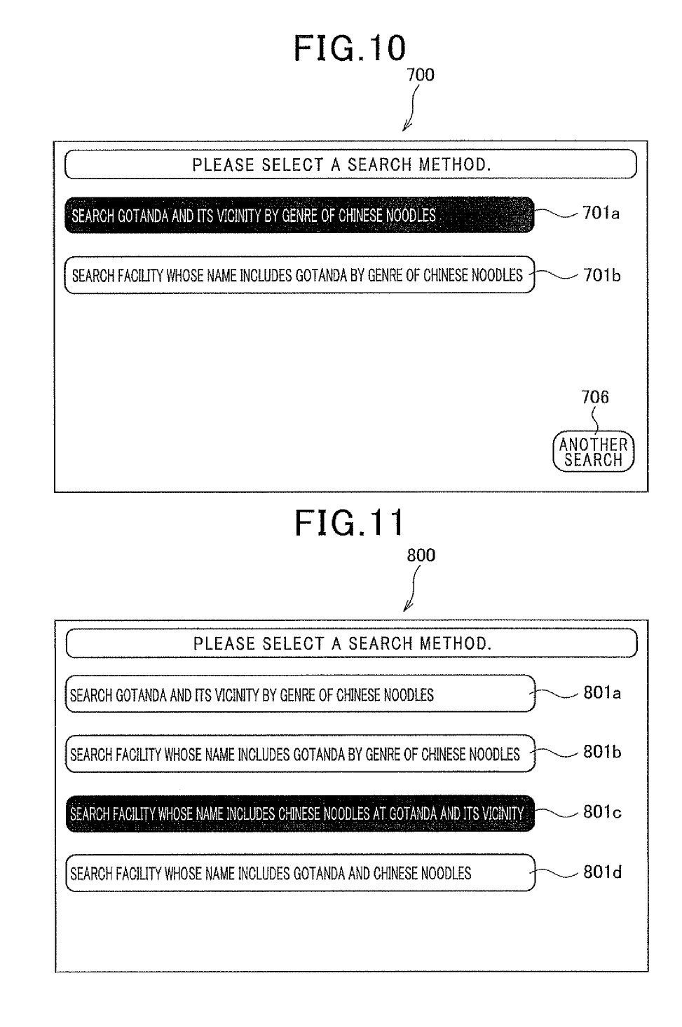

AS shown in FIG. 9A, a total judgment value of a set of “Gotanda (a name of facility)+Chinese noodles (a name of facility)” is “40+10=50”, a total judgment value of a set of “Gotanda (a name of facility)+Chinese noodles (a genre of Chinese noodles)” is “40+90=130”, a total judgment value of a set of “Gotanda (an address)+Chinese noodles (a name of facility)” is “60+10=70”, and a total judgment value of a set of “Gotanda (an address)+Chinese noodles (a genre of Chinese noodles)” is “60+90=150”. Therefore, a set which fulfills the above condition (A) is “Gotanda (a name of facility)+Chinese noodles (a genre of Chinese noodles)”, and “Gotanda (an address)+Chinese noodles (a genre of Chinese noodles)”. Since each of the keyword attributes “Gotanda (a name of facility)”, “Gotanda (an address)”, and “Chinese noodles (a genre of Chinese noodles)” which constitute these sets of keyword attributes is equal to or more than “30”, the above condition (B) is also fulfilled. Therefore, in an example shown in FIG. 9A, by an judgment value comparison process, a set of “Gotanda (a name of facility)+Chinese noodles (a genre of Chinese noodles)”, and a set of “Gotanda (an address)+Chinese noodles (a genre of Chinese noodles)” are extracted. Thus, in the case where a plurality of sets of keyword attributes have been extracted by a judgment value comparison process, in order to make a user select a keyword attribute constituting any set of keyword attributes, and an input keyword which a position search is conducted based on, a screen is changed from a keyword input screen 300 to a search method selection screen 700 shown in FIG. 10.

The search method selection screen 700 includes search method display areas 701a, 701b, and “another search” button 706. In the search method display areas 701a, 701b, in order to make a user select any of sets of keyword attributes extracted by a judgment value comparison process, a search method which corresponds to each set of keyword attributes is displayed. Sets of keyword attributes to be selected by a user are displayed in the respective search method display areas 701 in decreasing order of total judgment values calculated for the respective sets of keyword attributes. Here, a user can select any of sets of keyword attributes (search methods) which a position search is conducted based on. After any of sets of keyword attributes has been selected by a user, a judgment value of a search work file WF tied to a keyword attribute which constitutes the selected set of keyword attributes is updated in accordance with a predetermined learning rule.

Here, a learning rule in the case where any of sets of keyword attributes has been selected by a user will be described. The learning rule can be adequately set, if necessary. For example, as an example, in the case where any of sets of keyword attributes has been selected by a user, the following learning rule may be available: a predetermined addition value (in the embodiment, as an example, it is “10”. However, it may be another value, if necessary.) is added to a judgment value tied to each keyword attribute which constitutes the selected set of keyword attributes in a search work file WF, and a value is equally subtracted from a judgment value tied to the other keyword attribute so that a total of judgment values assigned to one keyword is maintained to be “100” (in the case where there is a keyword attribute whose judgment value becomes equal to or less than “0” due to the subtraction of value, however, all judgment values of a keyword corresponding to the keyword attribute are not updated.). FIG. 9B is a view showing a search work file WF after a judgment vale of a search work file WF shown in FIG. 9A has been updated in accordance with the above learning rule (in the case where the above predetermined addition value is “10”) , in the case where a set of keyword attributes “Gotanda (an address)+Chinese noodles (a genre of Chinese noodles)” has been selected by a user. As another example, a predetermined addition value may change in accordance with a magnitude of a judgment value to be added, or a judgment value tied to another keyword attribute . For example, the nearer to “100” (or the nearer to “0”) a judgment value of a certain keyword attribute is, the smaller a predetermined addition value may be.

Further, when “another search” button 706 on a search method selection screen 700 is operated by a user, in order to make a user select a keyword attribute constituting any set of keyword attributes in all sets of keyword attributes formed for a judgment value comparison process, and an input keyword which a position search is conducted based on, a screen is changed from a search method selection screen 700 to a search method selection screen 800 shown in FIG. 11.

The search method selection screen 800 includes search method display areas 801a, 801b, 801c, and 801d. In the search method display areas 801a, 801b, 801c, and 801d, in order to make a user select any of all sets of keyword attributes formed for a judgment value comparison process, search methods which correspond to the respective sets of keyword attributes are displayed. In the respective search method display areas 801, sets of keyword attributes to be selected by a user is displayed in decreasing order of total judgment values of the formed sets of keyword attributes. Similarly with a case of a search method selection screen 700, a user can select any of sets of keyword attributes (search methods) which a position search is conducted based on. Here, even if any set of keyword attributes has been selected by a user, a judgment value of a search work file WF is updated in accordance with a predetermined learning rule, similarly with the above. In the case where a user has selected a set of keyword attributes “Gotanda (an address)+Chinese noodles (a name of facility)”, a search work file WF assumed before an update based on the learning rule is shown in FIG. 9A, and a search work file WF assumed after an update based on the learning rule is shown in FIG. 9C. Thus, in the search method selection screen 800, even if a set of keyword attributes has been selected by a user, a learning process is performed.

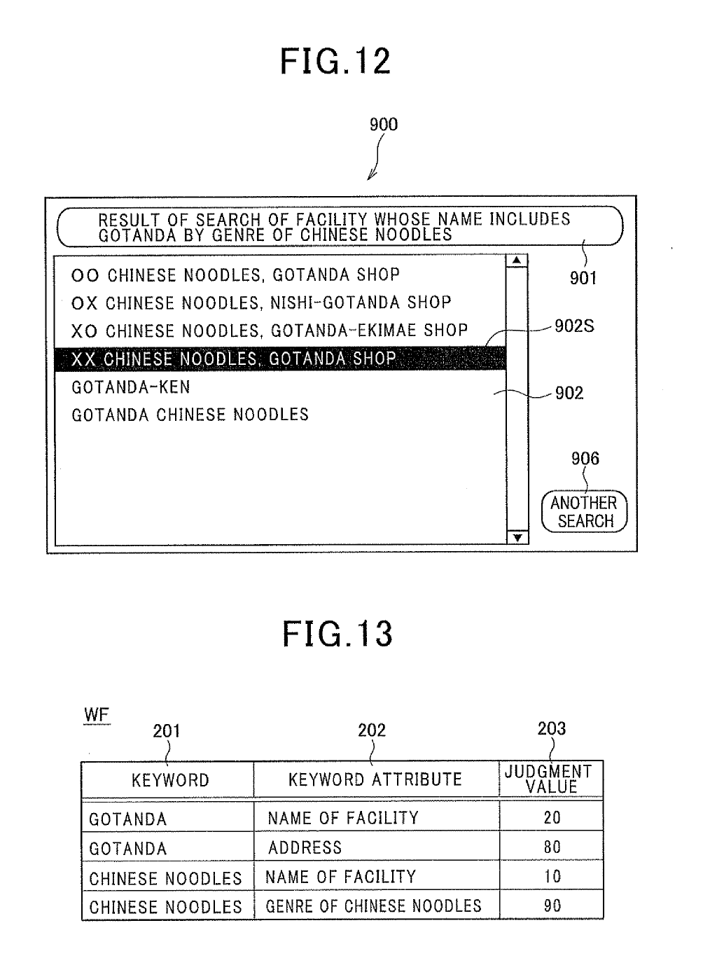

In a search method selection screen 700 or a search method selection screen 800, when any of sets of keyword attributes is selected by a user, a position search is conducted based on a keyword attribute constituting the selected set of keyword attributes, and an input keyword, and a screen is changed from a search method selection screen 700, 800 to a search result screen 900 shown in FIG. 12. The search result screen 900 includes a keyword/keyword attribute display area 901, a search result display screen 902, and “another search” button 906. In the keyword/keyword attribute display area 901, information indicative of any input keyword, and any set of keyword attributes which a position search has been conducted based on is displayed. In an example shown in FIG. 12, it is shown that a position search has been conducted based on input keywords “Gotanda”, “Chinese noodles”, and keyword attributes “Gotanda (a name of facility)”, “Chinese noodles (a genre of Chinese noodles)”. In the search result display area 902, a result of a position search conducted based on a keyword attribute constituting a set of keyword attributes, and an input keyword, is displayed. The respective areas indicative of position information searched in the search result display area 902 can be made into a selection condition by a cursor key, similarly with a search result display area 602 (see FIG. 7). In an example shown in FIG. 12, it is shown that an area 902S in which “xx Chinese noodles Gotanda shop” is displayed as position information is in a selection condition. By making any area in the search result display area 902 into a selection condition, and then pressing a decision button, a user can decide a position indicated by position information displayed in an area being in the selection condition, as a destination. After a destination has been decided, a judgment value of a keyword attribute file KF is updated based on a search work file WF. Further, in the case where “another search” button 906 has been pressed by a user, a judgment value of a search work file WF updated so far by a learning process is returned to a condition assumed before a learning process. After that, in order to make a user select again a set of keyword attributes other than a set of keyword attributes shown in a keyword/keyword attribute display area 901 from all formed sets of keyword attributes, a screen is changed from a search result screen 900 to a search method selection screen 800.

### [1.2.2.2] Case 2-2 (In the Case Where the Number of a Set of Keyword Attributes Extracted in a Judgment Value Comparison Process is One)

On the other hand, among sets of keyword attributes formed based on a search work file WF shown in FIG. 13, a set which fulfills the conditions of the above (A) and (B) is only a set of “Gotanda (an address)+Chinese noodles (a genre of Chinese noodles)” whose total judgment value is “80+90=170”. When the set of keyword attributes is extracted by a judgment value comparison process, a position search is conducted based on a keyword attribute constituting the extracted set of keyword attributes, and an input keyword, and a screen is changed from a keyword input screen 300 directly to a search result screen 900 shown in FIG. 12. A flow after the search result screen 900 has been displayed is similar with a case where a search result screen 900 is displayed in Case 2-1. In Case 2-2, however, when a search result screen 900 is first displayed, in the case where a destination has been decided based on position information displayed in a search result display area 902 without “another search” button. 906 pressed, a learning process is never performed, and an update process of a judgment value of a keyword attribute file KF based on a search work file WF is not performed.

### [1.3] Operation of a System Control Unit 101 in the Embodiment

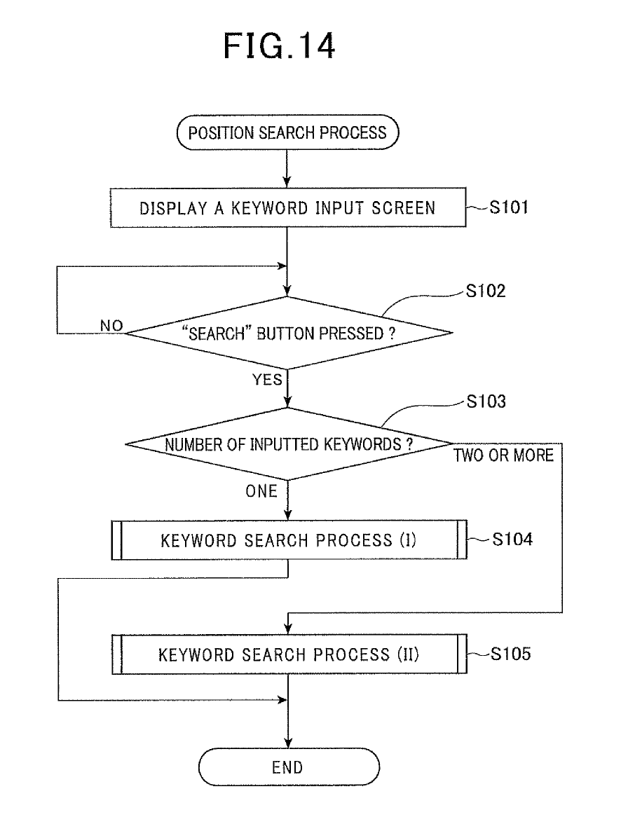

Referring now to FIG. 14 to FIG. 18, in a navigation apparatus 100 according to the embodiment, an operation of searching a position which is a destination based on a keyword search, and deciding a destination will be described in detail.

### {1.3.1} Position Search Process

As mentioned above, when a predetermined keyword search start operation is performed, a system control unit 101 starts a position search process. As shown in FIG. 14, first, a system control unit 101 outputs a control signal to a HD drive 102, and controls a display control unit 107 in such a way that a keyword input screen 300 shown in FIG. 3 is displayed in a display unit 108 (S101). At this time, the system control unit 101 detects the user's operation of a 50-sound input key 305, a conversion button 302, and a decision button 303, and controls the display control unit 107 in such a way that a character is displayed in a keyword input area 301, if necessary.

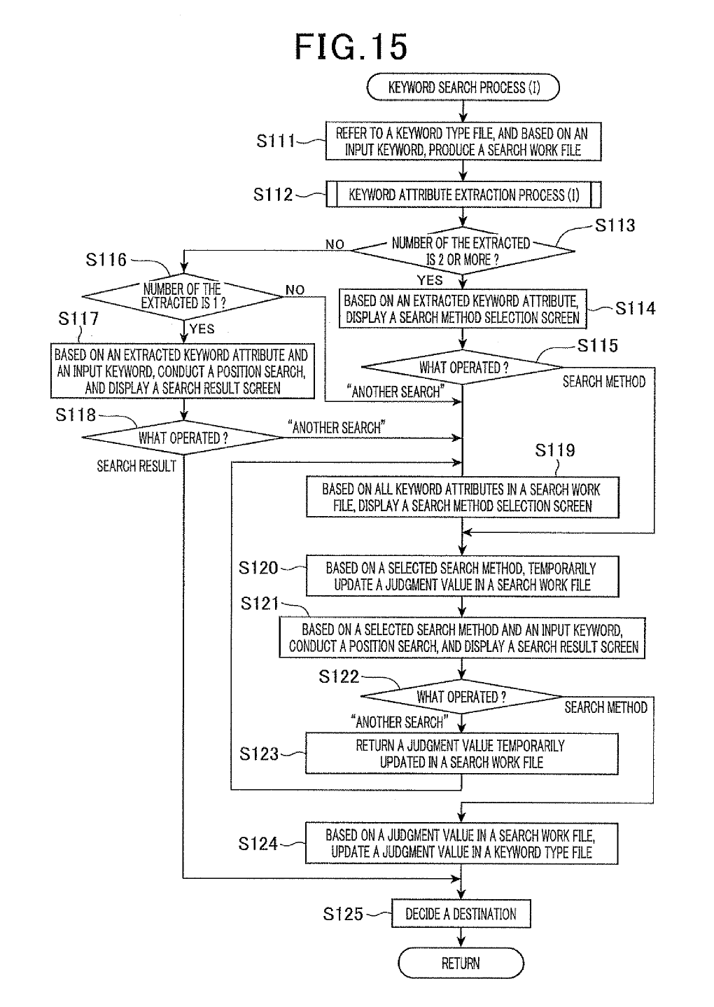

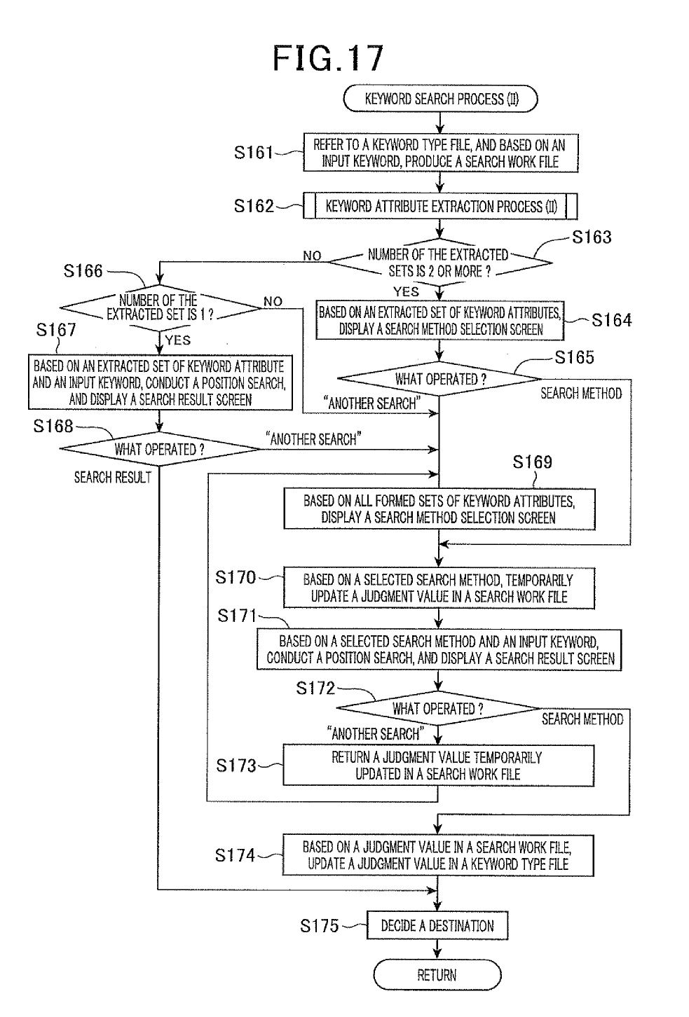

Then, while a keyword input screen 300 is displayed in the display unit 108, the system control unit 101 is made in a detection-waiting condition until the user's pressing of a search button 304 is detected (S102). In the case where the pressing of the search button 304 has been detected, then, the system control unit 101 judges the number of inputted keywords (S103). At this time, in the case where it has been judged that the number of inputted keywords is 1, the system control unit 101 performs a keyword search process (I) mentioned below, using FIG. 15 (S104), and terminates a position search process. On the other hand, in the case where it has been judged that the number of inputted keywords is 2 or more, the system control unit 101 performs a keyword search process (II) mentioned below, using FIG. 17 (S105), and terminates a position search process. In the case where the number of inputted keyword is 0, the system control unit 101 moves to 5101 so that a keyword is inputted, although this is not shown.

### [1.3.2] Keyword Search Process (I)

Referring now to FIG. 15, a keyword search process (I) will be described. As shown in FIG. 15, first, a system control unit 101 refers to a keyword type file KF, and produces a search work file WF based on an input keyword (S111). In the case where an input keyword is not identical to a keyword 201 of a keyword type file KF, a message of warning a user of that effect, and instructing a change of an input keyword is displayed.

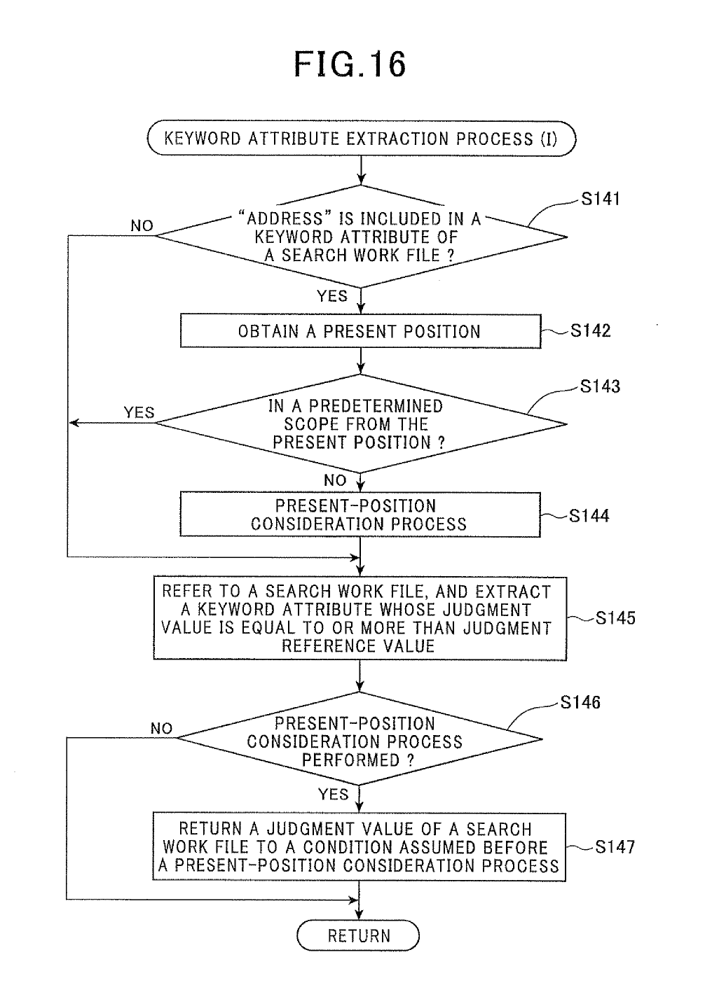

Then, the system control unit 101 performs a keyword attribute extraction process (I) mentioned below, using FIG. 16 (S112), and moves to S113. In the keyword attribute extraction process (I), a judgment value comparison process is performed. More specifically, based on a judgment value described in a search work file WF, and a judgment reference value, a keyword attribute corresponding to an input keyword is extracted.

Then, the system control unit 101 judges whether the number of keyword attributes extracted in a process of S112 is 2 or more (S113). At this time, in the case where it has been judged that the number of extracted keyword attributes is 2 or more, then, the system control unit 101 controls a display control unit 107 in such a way that a search method selection screen 400 shown in FIG. 5 is displayed in a display unit 108, based on the extracted keyword attribute. Then, the system control unit 101 judges whether an object operated in the search method selection screen 400 is “another search” button 406, or any search method display area 401 (S115). At this time, when it has been judged that an operated object is “another search” button 406, the system control unit 101 moves to a process of S119. On the other hand, when it has been judged that an operated object is any search method display area 401, the system control unit 101 moves to a process of S120.

On the other hand, in the case where it has been judged in a process of S113 that the number of keyword attributes extracted in a process of S112 is not 2 or more, then, the system control unit 101 judges whether the number of keyword attributes extracted in a process of S112 is 1 (S116). At this time, in the case where it has been judged that the number of extracted keyword attributes is not 1 (i.e., the number of extracted keyword attributes is 0), the system control unit 101 moves to a process of S119. on the other hand, in the case where it has been judged that the number of extracted keyword attributes is 1, the system control unit 101 conducts a position search based on the extracted keyword attribute and an input keyword, and controls a display control unit 107 in such a way that a search result screen 600 shown in FIG. 7 is displayed in a display unit 108 (S117). Then, the system control unit 101 judges whether an object operated in the search result screen 600 is “another search” button 606, or any area indicative of position information searched in a search result display screen 602 (S118). At this time, in the case where it has been judged that an operated object is any area indicative of position information searched in the search result display area 602, the system control unit 101 moves to a process of S125. On the other hand, in the case where it has been judged that an operated object is “another search” button 606, the system control unit 101 moves to a process of S119.

In the case where it has been judged in a process of S115 that an operated object is “another search” button 406, in the case where it has been judged in a process of S116 that the number of extracted keyword attributes is not 1, in the case where it has been judged in a process of S118 that an operated object is “another search” button 606, or after a process of 5123 mentioned below has been performed, then, the system control unit 101 controls a display control unit 107 based on all keyword attributes of a search work file WF in such a way that a search method selection screen shown in FIG. 6 is displayed in the display unit 108 (S119). When it is detected that any search method display area 501 has been selected while the search method selection screen 500 is displayed, the system control unit 101 moves to a process of S120.

Then, when it is judged in a process of 5115 that an operated object is any search method display area 401, or when it is detected in a process of S119 that any search method display area 501 has been operated, the system control unit 101 temporarily updates a judgment value of a search work file WF based on the selected search method (S120). Specifically, the system control unit 101 temporarily updates a judgment value of a search work file WF in accordance with a learning rule in the case where any keyword attribute has been selected by a user, as mentioned above. A selected search method is a search method corresponding to a search method display area 401 which has been judged to be operated in a process of 5115 (a keyword attribute), or a search method corresponding to a search method display area 501 which has been detected to be operated in a process of S119 (a keyword attribute).

Then, the system control unit 101 refers to a position search data recorded in a HD drive 102, conducts a position search based on the selected search method (a keyword attribute), and an input keyword, and controls a display control unit 107 in such a way that a search result screen 600 shown in FIG. 7 is displayed in a display unit 108 (S121).

Then, the system control unit 101 judges whether an object operated on a search result screen 600 is “another search” button 606, or any area indicative of position information searched in a search result display area 602 (S122). At this time, in the case where it has been judged that an operated object is “another search” button 606, the system control unit 101 returns a judgment value of a search work file WF temporarily updated in a process of S120 to a condition assumed before a temporary update (S123), and moves to a process of S119. On the other hand, in the case where it has been judged that an operated object is any area indicative of position information searched in the search result display area 602, then, the system control unit 101 updates a judgment value of a keyword type file KF based on a judgment value of a search work file WF (S124), and moves to a process of S125.

In the case where it has been judged in a process of S118 that an operated object is any area indicative of position information searched in a search result display area 602, or after a process of S124 has been performed, the system control unit 101 in a process of S118 or S122 decides a position indicative of position information displayed in an area which has been judged to be operated in the search result display area 602, as a destination (S125), and terminates a keyword search process (I).

### [1.3.31] Keyword Attribute Extraction Process (I)

Referring now to FIG. 16, a keyword attribute extraction process (I) will be described. As shown in FIG. 16, first, a system control unit 101 judges whether “an address” is included in a keyword attribute of a search work file WF produced in S111 (see FIG. 15) (S141). At this time, in the case where it has been judged that “an address” is not included in a keyword attribute of a search work file WF, the system control unit 101 moves to a process of S145. On the other hand, in the case where it has been judged that “an address” is included in a keyword attribute of a search work file WF, the system control unit 101 obtains the present position (S142).

Then, the system control unit 101 judges whether an input keyword is a keyword indicative of an address indicative of a position included in a predetermined scope from the present position (S143). AT this time, in the case where it has been judged that an input keyword is a keyword indicative of an address indicative of a position outside a predetermined scope from the present position, the system control unit 101 performs the above-mentioned present-position consideration process (S144). On the other hand, in the case where it has been judged that an input keyword is a keyword indicative of an address indicative of a position included in a predetermined scope from the present position, the system control unit 101 moves to a process of 5145.

After that, in the case where it has been judged in a process of S141 that “an address” is not included in a keyword attribute of a search work file WF, in the case where it has been judged in a process of S143 that an input keyword is a keyword indicative of an address indicative of a position included in a predetermined scope from the present position, or after a process of S144 has been performed, then, the system control unit 101 refers to a search work file WF, and extracts a keyword attribute whose judgment value is equal to or more than a judgment reference value (in the embodiment, “40”) (S145).

Then, the system control unit 101 judges in a process of S144 whether a present-position consideration process has been performed (S146). At this time, in the case where it is judged that the present-position consideration process has been performed, the system control unit 101 returns a judgment value of a search work file to a condition assumed before the present-position consideration process (S147), and terminates a keyword attribute extraction process (I). On the other hand, in the case where it is determined that the present-position consideration process has not been performed, the system control unit 101 terminates a keyword attribute extraction process (I).

### [1.3.4] Keyword Search Process (II)

Referring now to FIG. 17, a keyword search process (II) will be described. As shown in FIG. 17, first, the system control unit 101 refers to a keyword type file KF, and produces a search work file WF based on an input keyword (S161). In the case where an input keyword is not identical to a keyword 201 of a keyword type file KF, a message of warning a user of that effect, and instructing a change of an input keyword is displayed.

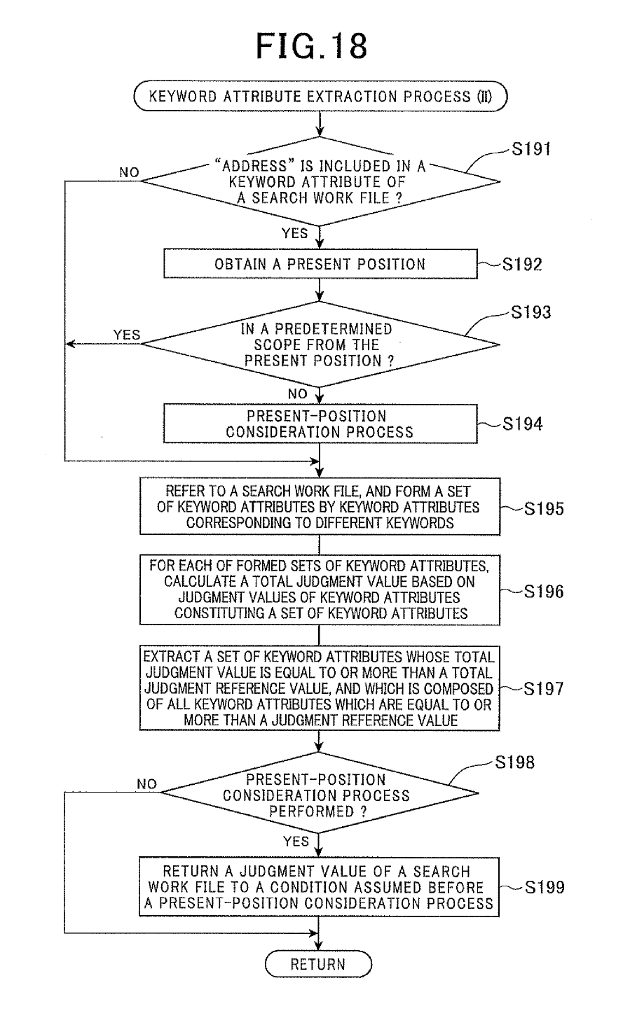

Then, the system control unit 101 performs a keyword attribute extraction process (II) mentioned below, using FIG. 18 (S112), and moves to S163. In the keyword attribute extraction process (II), a judgment value comparison process is performed. More specifically, based on a comparison of a total judgment value of sets of keyword attributes formed based on a search work file WF, with a total judgment reference value, or based on a comparison of a judgment value of a keyword attribute constituting a set of keyword attributes, with a judgment reference value, a keyword attribute corresponding to an input keyword is extracted.

Then, the system control unit 101 judges whether the number of sets of keyword attributes extracted in a process of S162 is 2 or more (S163). At this time, in the case where it has been judged that the number of extracted sets of keyword attributes is 2 or more, then the system control unit 101 controls a display control unit 107 in such a way that a search method selection screen 700 shown in FIG. 10 is displayed in a display unit 108, based on the extracted set of keyword attributes. Then, the system control unit 101 judges whether an object operated in the search method selection screen 700 is “another search” button 706 or any search method display area 701 (S165). At this time, when it has been judged that an operated object is “another search” button 706, the system control unit 101 moves to a process of S169. On the other hand, when it has been judged that an operated object is any search method display area 701, the system control unit 101 moves to a process of S170.

On the other hand, in the case where it has been judged in a process of S163 that the number of sets of keyword attributes extracted in a process of S162 is not 2 or more, then, the system control unit 101 judges whether the number of sets of keyword attributes extracted in a process of S162 is 1 (S166). At this time, in the case where it has been judged that the number of extracted sets of keyword attributes is not 1 (i.e., the number of extracted sets of keyword attributes is 0), the system control unit 101 moves to a process of S169. On the other hand, in the case where it has been judged that the number of extracted sets of keyword attributes is 1, the system control unit 101 conducts a position search based on a keyword attribute constituting the extracted sets of keyword attributes and an input keyword, and controls a display control unit 107 in such a way that a search result screen 900 shown in FIG. 12 is displayed in a display unit 108 (S167). Then, the system control unit 101 judges whether an object operated in the search result screen 900 is “another search” button 906, or any area indicative of position information searched in a search result display area 902 (S168). At this time, in the case where it has been judged that an operated object is any area indicative of position information searched in the search result display area 902, the system control unit 101 moves to a process of S175. On the other hand, in the case where it has been judged that an operated object is “another search” button 906, the system control unit 101 moves to a process of S169.

In the case where it has been judged in a process of S165 that an operated object is “another search” button 706, in the case where it has been judged in a process of S166 that the number of extracted sets of keyword attributes is not 1, in the case where it has been judged in a process of S168 that an operated object is “another search” button 906, or after a process of S173 mentioned below has been performed, then, the system control unit 101 controls a display control unit 107 based on all sets of keyword attributes formed in a process of S195 mentioned below (see FIG. 18) in such a way that a search method selection screen 800 shown in FIG. 11 is displayed in the display unit 108 (S169). When the system control unit 101 detects that any search method display area 801 has been selected while the search method selection screen 800 is displayed, the system control unit 101 moves to a process of S170.

Then, when the system control unit 101 judges in a process of S165 that an operated object is any search method display area 701, or when the system control unit 101 detects in a process of S169 that any search method display area 801 has been operated, the system control unit 101 temporarily updates a judgment value of a search work file WF based on the selected search method (S170). Specifically, the system control unit 101 temporarily updates a judgment value of a search work file WF in accordance with a learning rule in the case where any set of keyword attribute has been selected by a user, as mentioned above. A selected search method is a search method (a keyword attribute) corresponding to a search method display area 701 which has been judged to be operated in a process of S165, or a search method (a keyword attribute) corresponding to a search method display area 801 which has been detected to be operated in a process of S169.

Then, the system control unit 101 refers to a position search data recorded in a HD drive 102, conducts a position search based on the selected search method (a keyword attribute constituting a set of keyword attributes), and an input keyword, and controls a display control unit 107 in such a way that a search result screen 900 shown in FIG. 12 is displayed in a display unit 108 (S171).

Then, the system control unit 101 judges whether an object operated on a search result screen 900 is “another search” button 906, or any area indicative of position information searched in a search result display area 902 (S172). At this time, in the case where it has been judged that an operated object is “another search” button 906, the system control unit 101 returns a judgment value of a search work file WF temporarily updated in a process of S170 to a condition assumed before a temporary update (S173), and moves to a process of S169. On the other hand, in the case where it has been judged that an operated object is any area indicative of position information searched in the search result display area 902, then, the system control unit 101 updates a judgment value of a keyword type file KF based on a judgment value of a search work file WF (S174), and moves to a process of S175.

In the case where it has been judged in a process of S168 that an operated object is any area indicative of position information searched in a search result display area 902, or after a process of S174 has been performed, the system control unit 101 decides a position indicative of position information displayed in an area which has been judged to be operated in the search result display area 902 in a process of S168 or S172, as a destination (S175), and terminates a keyword search process (II).

### [1.3.5] Keyword Attribute Extraction Process (II)

Referring now to FIG. 18, a keyword attribute extraction process (II) will be described. As shown in FIG. 18, first the system control unit 101 judges whether “an address” is included in a keyword attribute of a search work file WF produced in S161 (see FIG. 17) (S191). At this time, in the case where it has been judged that “an address” is not included in a keyword attribute of a search work file WF, the system control unit 101 moves to a process of S195. On the other hand, in the case where it has been judged that “an address” is included in a keyword attribute of a search work file WF, the system control unit 101 obtains the present position (S192).

Then, the system control unit 101 judges whether an input keyword is a keyword indicative of an address indicative of a position included in a predetermined scope from the present position (S193).

AT this time, in the case where it has been judged that an input keyword is a keyword indicative of an address indicative of a position outside a predetermined scope from the present position, the system control unit 101 performs the above-mentioned present-position consideration process (S194). On the other hand, in the case where it has been judged that an input keyword is a keyword indicative of an address indicative of a position included in a predetermined scope from the present position, the system control unit 101 moves to a process of S195.

After that, in the case where it has been judged in a process of S191 that “an address” is not included in a keyword attribute of a search work file WF, in the case where it has been judged in a process of S193 that an input keyword is a keyword indicative of an address indicative of a position included in a predetermined scope from the present position, or after a process of S194 has been performed, then, the system control unit 101 refers to a search work file WF, and forms a set of keyword attributes by keyword attributes corresponding to different keywords (S195).

Then, the system control unit 101 calculates a total judgment value based on a judgment values of keyword attributes constituting a set of keyword attributes for each of the formed sets of keyword attributes (S196).

The system control unit 101 extracts a set of keyword attributes whose total judgment value is equal to or more than a total judgment reference value (in the embodiment, “100”), and all keyword attributes of which have a value equal to or more than a judgment reference value (in the embodiment, “30”) (S197).

The system control unit 101 judges in a process of S194 whether a present-position consideration process has been performed (S198). At this time, in the case where it is determined that the present-position consideration process has been performed, the system control unit 101 returns a judgment value of a search work file to a condition assumed before the present-position consideration process (S199), and terminates a keyword attribute extraction process (II). On the other hand, in the case where it is determined that the present-position consideration process has not been performed, the system control unit 101 terminates a keyword attribute extraction process (II).

As mentioned above, a navigation apparatus 100 is arranged to include:

a HD drive 102 (an example of “a storage device” of the invention) in which a keyword attribute file KF (an example of “attribute correspondence information” of the invention) in which a judgment value is tied to each of one or a plurality of keyword attributes corresponding to a keyword which can be inputted by a user is stored,

a system control unit 101 (an example of “an extraction device” of the invention) which performs a judgment value comparison process (an example of “an extraction process” of the invention) of extracting a keyword attribute which corresponds to a keyword inputted by a user, wherein a search work file WF obtained by a replication of a portion of a keyword attribute file KF is referenced, and a judgment value tied to the keyword attribute is equal to or more than a judgment reference value (an example of “a extraction threshold” of the invention), and

a system control unit 101 (an example of “a providing device” of the invention) which performs a position search of searching position information (an example of “search object information” of the invention) of setting a destination based on the extracted keyword attribute, and a keyword inputted by a user, and controls a display control unit 107 in such a way that a search result screen such as a search result screen 600 is displayed in a display unit 208 in order to provide a search result to a user.

In accordance with this arrangement, concerning a navigation apparatus 100,

in a HD drive 102, a keyword attribute file KF in which a judgment value is tied to each of one or a plurality of keyword attributes corresponding to a keyword which can be inputted by a user is stored,

a system control unit 101 performs a judgment value comparison process of extracting a keyword attribute which corresponds to a keyword inputted by a user, wherein a search work file WF obtained by a replication of a portion of a keyword attribute file KF is referenced, and a judgment value tied to the keyword attribute is equal to or more than a judgment reference value, and

a system control unit 101 performs a position search of searching position information of setting a destination based on the extracted keyword attribute, and a keyword inputted by a user, and controls a display control unit 107 in such a way that a search result screen such as a search result screen 600 is displayed in a display unit 208 in order to provide a search result to a user.

Therefore, in accordance with a navigation apparatus 100, at the time of a keyword search for a position search, based on an input keyword, and a keyword attribute extracted by a judgment value comparison process, a position search is performed, so a user can obtain a search result without judging that it is optimum as what keyword attribute an input keyword should be handles, resulting in a reduction of load.

In the case where the number of keyword attributes extracted in a judgment value comparison process is plural, a system control unit 101 (an example of “a keyword attribute obtaining device” of the invention) notifies a plurality of the extracted keyword attributes, using a search method selection screen shown in a search method selection screen 400, in order to make a user select any keyword attribute (search method) from a plurality of the keyword attributes, and obtains a keyword attribute selected by a user from the notified keyword attributes (search methods), and performs a position search based on the obtained keyword attribute and an input keyword, and in order to provide a search result to a user, controls a display control unit 107 in such a way that a search result screen such as a search result screen 600 is displayed in a display unit 208. Thus, even if the number of keyword attributes extracted in a judgment value comparison process is not only 1, a user can obtain an expected search result.

Further, in the case where the number of keyword attributes extracted in a judgment value comparison process is plural, a system control unit 101 (an example of “an update device” of the invention), based on the fact that any keyword attribute (search method) has been selected on a search method selection screen such as a search method selection screen 400 by a user, updates a judgment value (adds “10”), into any one of a condition where a judgment value tied to the selected keyword attribute becomes to a value equal to or more than a judgment reference value in the next judgment value comparison process, and a condition where the difference between the judgment value and the judgment reference value becomes small. Thus, after the next time, a keyword attribute selected by a user is easy to extract in a judgment value comparison process, and it is easy for a user to obtain a search result without selecting a keyword attribute on a search method selection screen such as a search method selection screen 400.

Further, although a present-position consideration process is performed in the embodiment, a reference-position consideration process in which, instead of the present position, for example, a position selected by a user is a reference position may be arranged to be performed. That is, in the case where an input keyword is a keyword indicative of an address indicative of a position not included in a predetermined scope from the present position (an example of “a specific position” of the invention), or a reference position (an example of “a specific position” of the invention) selected by a user, and an address is tied to the input keyword as a keyword attribute, a system control unit 101 (an example of “a specific position obtaining device” of the invention) temporarily updates a judgment value (subtract “20”) into any one of a condition where a judgment value tied to an address of the keyword attribute becomes less than a judgment reference value, and a condition where the difference between the judgment value and the judgment reference value becomes small, and extracts a keyword attribute in a judgment value comparison process. In the case where an input keyword is a keyword indicative of an address indicative of a position included in a predetermined scope from the present position or a reference position selected by a user, and an address is tied to the input keyword as a keyword attribute, a system control unit 101 may be arranged to temporarily update a judgment value (add “20”) into any one of a condition where a judgment value tied to an address of the keyword attribute becomes to a value equal to or more than a judgment reference value, and a condition where the difference between the judgment value and the judgment reference value becomes small, and then, extract a keyword attribute in a judgment value comparison process. Thus, a keyword attribute of “an address” is difficult or easy to extract in accordance with the present position or a reference position in a judgment value comparison process, and therefore, it is easy to obtain a search result in which the present position or a reference position has been taken into account.

Further, a system control unit 101 causes search methods (keyword attributes) to be selected by a user to be displayed in decreasing order of their judgment values in a search method display area such as a search method display area 401 on a search method selection screen such as a search method selection screen 400. Here, in the embodiment, a judgment value tied to a keyword attribute which is expected to be extracted in a judgment value comparison process by a user is arranged to be a big value. However, contrary thereto, an arrangement in which a judgment value tied to a keyword attribute which is expected to be extracted by a user is a small value, and in which a keyword attribute whose judgment value is equal to or less than a judgment reference value is extracted in a judgment value comparison process, may be possible. In the case of this arrangement, a system control unit 101 causes search methods (keyword attributes) to be selected by a user to be displayed in increasing order of their judgment values in a search method display area on a search method selection screen. In the embodiment, in the case a plurality of keyword attributes have been extracted in a judgment value comparison process, a search method selection screen is caused to be displayed, so that an extracted keyword attribute is notified. However, instead thereof, an arrangement in which sound outputted from a speaker 110 makes a notification may be possible. Thus, keyword attributes to be selected are notified in decreasing order of probabilities of the user's selection, so a selection is easy when a user selects any thereof.

Further, an arrangement may be possible, in which a system control unit 101 (an example of “a count device” and “a change device” of the invention) counts the number of pressing of “another search” button such as “another search” button 406, 506 on a search method selection screen such as a search method selection screen 400, 500, and based on the number, changes a judgment reference value in such a way that the number of judgment values equal to or more than the judgment reference value is big. For example, in the case where “another search” button has been pressed five times or more in a ten-time display of a search method selection screen, a judgment reference value may be lowered by “5”. Thus, more keyword attributes are easy to extract in a judgment value comparison process. Therefore, the number of occurrence of condition, in which a plurality of keyword attributes have been extracted in a judgment value comparison process while there are no keyword attributes therein which a user desires to select, can be decreased.

Further, in the case where a plurality of keywords have been inputted, a system control unit 101 (an example of “a keyword attribute set extraction device” of the invention) refers to a search work file WF which is a replica of a portion of a keyword attribute file KF, forms a set of keyword attributes which is composed of a combination of the respective keyword attributes corresponding to the different input keywords, and based on a comparison of judgment values tied to the respective keyword attributes constituting the set of keyword attributes with a total judgment reference value (an example of “a set extraction threshold” of the invention), extracts a set of keyword attributes, and based on a keyword attribute constituting the extracted set of keyword attributes, and each input keyword, conducts a position search of searching position information for setting a destination, and in order to provide a search result to a user, controls a display control unit 107 in such a way a search result screen such as a search result screen 900 is displayed in a display unit 208. Thus, at the time of a keyword search for conducting a position search, based on an input keyword, and a keyword attribute constituting a set of keyword attributes extracted by a judgment value comparison process, a position search is conducted, so a user can obtain a search result without judging that it is optimum as which attribute each input keyword is handled, resulting in a reduction of load.

Further, in the case where the number of sets of keyword attributes extracted in a judgment value comparison process is plural, a system control unit 101 (an example of “a keyword attribute set obtaining device” of the invention), in order to make a user select any set of keyword attributes (search methods) from a plurality of the sets of keyword attributes, notifies a plurality of the extracted sets of keyword attributes, using a search method selection screen such as a search method selection screen 700, obtains a set of keyword attributes selected by a user from the notified sets of keyword attributes (search methods), and based on a keyword attribute constituting the obtained set of keyword attributes, and an input keyword, conducts a position search, and in order to provide a search result to a user, controls a display control unit 107 in such a way that a search result screen such as a search result screen 900 is displayed in a display unit 208. Thus, even if the number of sets of keyword attributes extracted in a judgment value comparison process is not only one, a user can obtain an expected search result.

In the embodiment, a system control unit 101 performs a present-position consideration process, a judgment value comparison process, and a learning process for a search work file WF which is a replica of a portion of a keyword attribute file KF, and referring to a search work file WF, forms a set of keyword attributes. This is for reducing a possibility that a keyword attribute file KF is damaged due to an unforeseen situation in each process. Therefore, it may be possible to perform such a process directly for a keyword attribute file KF, and to refer to a keyword attribute file KF, and form a set of keyword attributes. In this case, however, it is desirable to take steps, such as preparing a backup file of a keyword attribute file KF, in order to provide for a case where an unforeseen situation occurs.

By recording a program corresponding to a process performed by a system control unit 101 mentioned above in an information recording medium such as a flexible disc, or a hard disc, and reading out and executing the program by a computer included in an information providing apparatus which has a storage unit in which a keyword attribute file KF is stored, the computer can be also utilized as a system control unit 101 in a navigation apparatus 100 according to the embodiment.

It should be understood that various alternatives to the embodiment of the invention described herein may be employed in practicing the invention. Thus, it is intended that the following claims define the scope of the invention, and that methods and structures within the scope of these claims and their equivalents be covered thereby.

The entire disclosure of Japanese Patent Application No. 2009-93779 filed on Apr. 8, 2009 including the specification, claims, drawings and abstract is incorporated herein by reference in its entirety.

What is claimed is:

1. An information providing apparatus for searching information to be searched based on a keyword inputted by a user, and a keyword attribute corresponding to the keyword, and providing it to a user, the information providing apparatus comprising:
a storage device configured to store attribute correspondence information which brings a keyword which can be inputted by a user in correspondence with one or a plurality of keyword attributes, and ties a judgment value to each of the keyword attributes,
an extraction device configured to refer to the attribute correspondence information, and to perform an extraction process of extracting a keyword attribute based on the judgment value tied to a keyword attribute corresponding to the inputted keyword, and a predetermined extraction threshold which is an extraction reference of the keyword attribute, and
a providing device configured to search information to be searched based on a keyword attribute extracted by the extraction device, and the inputted keyword, and provide it to a user.

2. An information providing apparatus according to claim 1, further comprising a keyword attribute obtaining device configured to, in the case where the number of keyword attributes extracted by the extraction device is plural, in order to make a user select any keyword attribute from a plurality of the keyword attributes, notify a plurality of the extracted keyword attributes, and obtain a keyword attribute selected by a user among the notified keyword attributes,
wherein in the case where any keyword attribute has been obtained by the keyword attribute obtaining device, the providing device searches the information to be searched based on the obtained keyword attribute and the inputted keyword, and providing it to a user.

3. An information providing apparatus according to claim 2,
further comprising an update device configured to, based on the fact that any keyword attribute has been obtained by the keyword attribute obtaining device, update a judgment value into any one of a condition where a judgment value tied to the obtained keyword attribute exceeds the extraction threshold in an extraction process of the next time, and a condition where the difference between the judgment value and the extraction threshold is small.

4. An information providing apparatus according to claim 1,
further comprising a specific position obtaining device configured to obtain the present position, or a position selected by a user as a specific position,
wherein in the case where the inputted keyword is a keyword indicative of an address indicative of a position not included in a predetermined scope from the obtained specific position, and an address is tied to the inputted keyword as a keyword attribute, the extraction device temporarily updates a judgment value into any one of a condition where the judgment value tied to an address of the keyword attribute does not exceed the extraction threshold, and a condition where the difference between the judgment value and the extraction threshold is small, and then, extracts a keyword attribute.

5. An information providing apparatus according to claim 1,
further comprising a specific position obtaining device configured to obtain the present position, or a position selected by a user as a specific position,
wherein in the case where the inputted keyword is a keyword indicative of an address indicative of a position included in a predetermined scope from the set specific position, and an address is tied to the inputted keyword as a keyword attribute, the extraction device temporarily updates a judgment value into any one of a condition where the judgment value tied to an address of the keyword attribute exceeds the extraction threshold, and a condition where the difference between the judgment value and the extraction threshold is small, and then, extracts a keyword attribute.

6. An information providing apparatus according to claim 2,
wherein in the case where the number of keyword attributes extracted by the extraction device is plural, in order to make a user select any keyword attribute from a plurality of the keyword attributes, the keyword attribute obtaining device notifies a user of a plurality of the extracted keyword attributes in any one of decreasing order and increasing order of judgment values tied to the keyword attributes.

7. An information providing apparatus according to claim 2,
wherein the keyword attribute obtaining device comprises:
a count device configured to, while a user has been notified of a plurality of keyword attributes extracted by the extraction device, count the number of times at which any keyword attributes have not been selected by a user, and
a change device configured to, based on the counted number of times, change a extraction threshold in such a way that the number of judgment values exceeding the extraction threshold is large.

8. An information providing apparatus according to claim 1,
further comprising a keyword attribute set extraction device configured to, in the case where a plurality of keywords have been inputted, refer to the attribute correspondence information, form a set of keyword attributes constituted by a combination of keyword attributes tied to the different inputted keywords, and based on a comparison of judgment values tied to the respective keyword attributes constituting the set of keyword attributes with a predetermined set extraction threshold which is an extraction reference of the set of keyword attributes, extract a set of keyword attributes,
wherein based on a keyword attribute constituting a set of keyword attributes extracted by the keyword attribute set extraction device, and the inputted keyword, the providing device searches the information to be searched, and provide it to a user.

9. An information providing apparatus according to claim 8,
further comprising a keyword attribute set obtaining device configured to, in the case where the number of sets of keyword attributes extracted by the keyword attribute set extraction device is plural, in order to make a user select any set of keyword attributes from a plurality of sets of the keyword attributes, notify a plurality of the extracted sets of keyword attributes, and obtain a set of keyword attribute selected by a user from the notified sets of keyword attributes,
wherein in the case where any set of keyword attribute has been obtained by the keyword attribute set obtaining device, the providing device searches the information to be searched based on a keyword attribute constituting the obtained set of keyword attributes, and the inputted keyword, and providing it to a user.

10. An information providing method, comprising:
an extraction process of bringing a keyword which can be inputted by a user in correspondence with one or a plurality of keyword attributes, referring to attribute correspondence information which ties a judgment value to each of the keyword attributes, and based on the judgment value tied to a keyword attribute corresponding to a keyword inputted by a user, and a predetermined extraction threshold which is an extraction reference of the keyword attribute, extracting a keyword attribute, and
a providing process of searching information to be searched based on a keyword attribute extracted in the extraction process, and the inputted keyword, and provide it to a user.

11. A computer-readable recording medium in which an information providing program is recorded,
the information providing program making a computer included in an information providing apparatus which comprises a storage device configured to store attribute correspondence information which brings a keyword which can be inputted by a user in correspondence with one or a plurality of keyword attributes, and ties a judgment value to each of the keyword attributes, the information providing apparatus searching information to be searched based on a keyword inputted by a user, and a keyword attribute of the keyword, and providing it to a user, function as:
an extraction device configured to refer to the attribute correspondence information, and based on the judgment value tied to a keyword attribute corresponding to the inputted keyword, and a predetermined extraction threshold which is an extraction reference of the keyword attribute, perform an extraction process of extracting a keyword attribute, and
a providing device configured to search information to be searched based on a keyword attribute extracted by the extraction device, and the inputted keyword, and provide it to a user.
